(19) United States
(12) Patent Application Publication
(10) Pub. No.: US 2011/0297459 A1
(43) Pub. Date: Dec. 8, 2011

(54) SOLAR POWERED ELECTRIC MOTOR VEHICLE

(75) Inventors: Nicolas Georges Hayek, Meisterschwanden (CH); Nayla Hayek, Hergiswil (CH); Marianne Hayek, Meisterschwarden (CH)

(73) Assignee: HAYEK ENGINEERING AG, Meisterschwanden (CH)

(21) Appl. No.: 12/809,493

(22) PCT Filed: Dec. 17, 2008
(86) PCT No.: PCT/EP2008/067767

§ 371 Date: Jun. 10, 2011

(30) Foreign Application Priority Data
Dec. 18, 2007 (CH) 01975/07

(51) Int. Cl. B60L 8/00

(52) U.S. Cl. 180/2.2

(57) ABSTRACT

The electric car is practically entirely covered in solar cells. Further, transparent solar cells are incorporated into the windshield and into the other windows of the car. The various features of the car give it considerable autonomy.

The present invention concerns an electric motor vehicle fitted with at least one rechargeable battery for supplying the vehicle with electricity. The present invention concerns, more specifically, a vehicle of this type fitted with solar photovoltaic cells.

Electric motor vehicles powered by rechargeable batteries have been known since the 19th century. These vehicles have numerous advantages. In particular, they are not noisy, do not emit exhaust gas, and theoretically can reduce our dependence on petrol. However, the batteries of these vehicles have to be charged. This operation is usually carried out using the electric power grid, either at home, or by going to a battery charging station that is open to the public.

Using batteries to power a car or other vehicle has some drawbacks. Indeed, to give this type of electric car sufficient autonomy, the batteries provided must have sufficient capacity to accumulate at least 20 kWh of electric power. Since conventional lead batteries can only accumulate around 40 Wh per kg, the requirement for a car to store this quantity of power involves at least 500 kg of extra weight. Li-ion batteries can accumulate around 5 times more energy per kg. However, at the present time, these batteries are extremely expensive.

Moreover, as already stated, batteries for electrically powered cars are normally charged with electricity from the power grid. We know that a significant fraction of power grid electricity is generated by nuclear power plants, which produce radio-active waste, or by coal or petrol plants that release large quantities of CO₂ into the atmosphere. Thus, at the end of the day, electrically powered cars cause just as much pollution as cars that run on petrol.

Electrically powered cars that have at least part of their bodywork covered in photovoltaic cells are also known. The use of photovoltaic cells theoretically overcomes the aforementioned drawbacks of cars powered by a rechargeable battery. Indeed, the additional electricity obtained from the photovoltaic cells increases the car's autonomy between two battery charging operations, or alternatively, provides the same autonomy with smaller batteries. Moreover, solar electricity is renewable clean energy. Unfortunately, in a temperate country, like Switzerland, the total quantity of electric energy produced by 1 m² of photovoltaic cells does not, on average, exceed 10 to 15 kWh per month. In these circumstances, to obtain a significant gain, the surface covered by the photovoltaic cells has to be as large as possible.

WO Patent Application No. 2007/059493 discloses a motor vehicle fitted with a rechargeable battery and photovoltaic cell panels for charging the battery. This prior art document proposes a solar panel configuration that is supposed to make the best use of the available space. Thus, the vehicle disclosed includes a first solar panel, which covers the roof, a second solar panel, which covers the hood or bonnet and a third, folding, solar panel, which is hinged to the first solar panel. The third panel is unfolded onto the windshield when the vehicle is stationary.

This prior solution also has some drawbacks. In particular, when it is unfolded, the third solar panel entirely blocks the windshield. Thus, to allow the driver to see the road, the panel has to be folded back when the vehicle is in use. In that position, the useful surface of the solar panels is greatly reduced. Further, the presence of rectangular panels fixed to the roof of the vehicle has detrimental consequences both for the aerodynamics and aesthetics of the vehicle.

It is therefore an object of the present invention to overcome the aforementioned drawbacks of the prior art. It achieves this object by providing an electrically powered vehicle fitted with at least one rechargeable battery in accordance with claim 1.

Because the transparent material forming the windshield includes a layer of transparent solar cells, the windshield surface can be used for generating solar power without thereby compromising visibility. Moreover, because the solar cells covering the bodywork follow the curves of said bodywork, the presence of solar cells does not need to have any detrimental effect on the aerodynamics or aesthetics of the vehicle.

According to an advantageous variant, the solar cells that cover the bodywork are high yield, combined optical photovoltaic cells. These cells are hybrid structures, which combine photovoltaic elements with optical elements, provided for concentrating light on the photovoltaic elements. These optical elements may include, in particular, converging lenses. One advantage of these combined solar cells is that they can have a yield of more than 40% or even 50%.

According to a second advantageous variant, the batteries used are “high performance” batteries that can accumulate at least 160 Wh per kg and even, preferably, at least 200 Wh per kg. Because of this feature, the vehicle weight can be reduced. In these circumstances, electric power consumption is also reduced. Further, since power consumption is reduced, the share of electricity provided by the solar cells increases proportionately. Thus, in the case of a car that associates the use of solar cells with high performance batteries, the effect of the solar cells on autonomy is further amplified.

According to another advantageous variant, the batteries used are the type that can be charged very quickly. These batteries can be charged to up to 80% of their full capacity in one minute. This feature means that the complication caused by having to stop at a battery charging station during a journey becomes entirely acceptable. This complication is not, in fact, any longer than that caused by stopping in a petrol station with a normal car. This latter variant thus overcomes problems arising from too little autonomy.

Other features and advantages of the present invention will appear upon reading the following description, given solely by way of non-limiting example, with reference to the annexed drawings, in which:

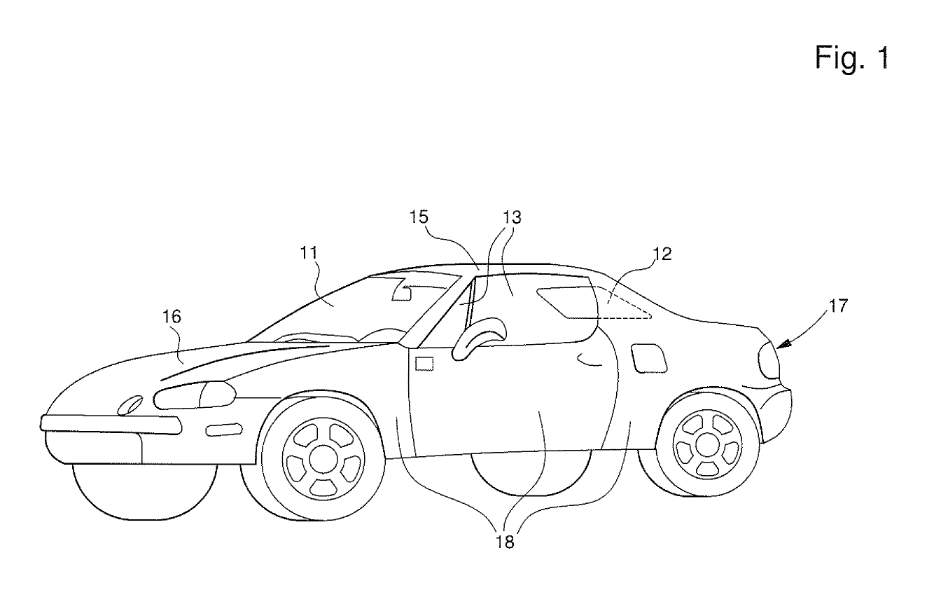

FIG. 1 is a side elevation of a solar powered electric car according to a particular embodiment of the invention;

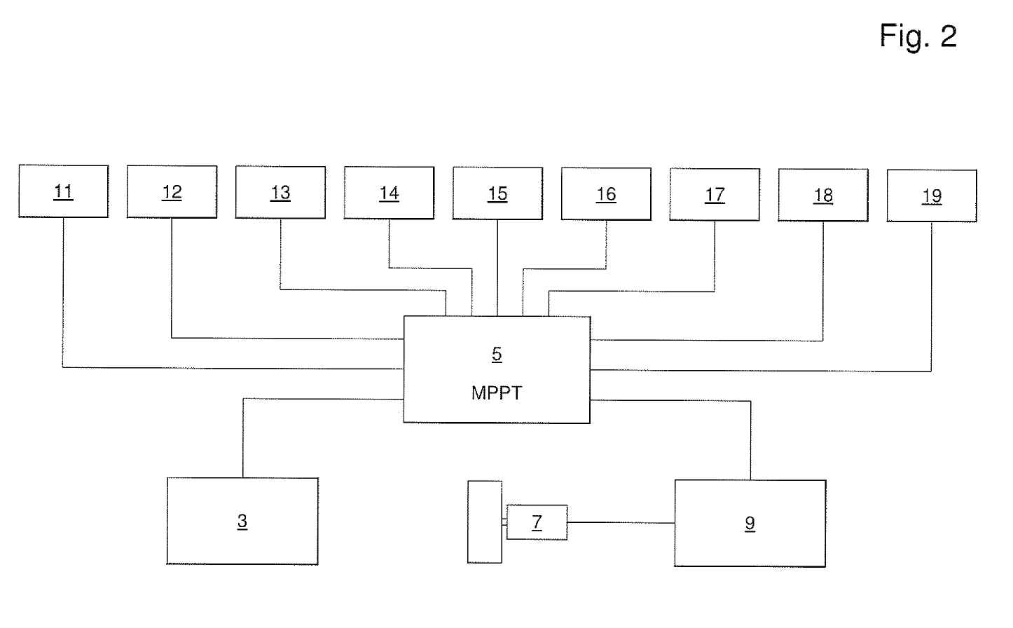

FIG. 2 is a flow diagram of the electric power system for the synchronous motors fitted to the solar powered electric vehicle of FIG. 1.

At first sight, the outward appearance of the motor vehicle shown in FIG. 1 does not differ at all from a normal car. Indeed, the present invention is not absolutely limited to a vehicle of any particular shape, since the vehicle body may be of any shape. However, in the present example, the bodywork exterior has the peculiarity of being practically entirely covered with photovoltaic cells. Preferably, when the various elements forming the bodywork are being manufactured, the photovoltaic cells are formed by depositing thin layers of doped amorphous silicon on an opaque material that forms the core of the various bodywork elements. Once deposited, the silicon is coated again with a transparent protective layer. The individual photovoltaic cells are connected to electric connectors arranged inside the bodywork. The connection between the cells and the connectors is preferably achieved via conductive paths, which are also deposited in the form of thin layers.

The array of photovoltaic cells on the bodywork is preferably subdivided into several areas in which the cells share the same orientation. In this example, there are five areas, namely: the roof area 15, the bonnet or hood area 16, the back area 17, the left side area 18, and finally the right side area 19 (not shown in FIG. 1). All the cells in the same area are interconnected.

According to an advantageous variant, the solar cells that cover the bodywork are high yield optical-photovoltaic cells. Solar cells of this type are generally formed of several semiconductor layers formed one on top of the other. Forming such stacks means forming multiple superposed junctions. Cells of this type are thus called multi-junction photovoltaic cells. The various layers forming one photovoltaic cell are chosen such that each junction absorbs light in a different band of the spectrum. Further, the layers are organized such that, for example, the most energetic photons are absorbed by the top layers and the least energetic photons by the bottom layers.

An array of optical concentrators is also placed before the array formed by the multi-junction cells. In a known mariner, the focal distance of the optical concentrators depends upon the light wavelength. Thus, the various bands of the spectrum can be respectively concentrated on the various junctions of the multi-layered photovoltaic cell. These multi-junction photovoltaic cells can have a much higher yield than that of a conventional photovoltaic cell.

Those skilled in the art will understand that it is also possible to make multi-junction cells in a lateral architecture. In such case, several cells, each absorbing light within a different band of the spectrum, are arranged side by side. An array of optical elements, including chromatic dispersion elements, such as prisms, for example, is placed before the array formed by the photovoltaic cell arrangement. The combination of chromatic dispersion elements and concentrators allows the various bands of the spectrum to focus respectively on the various photovoltaic cells arranged side by side. Moreover, it is also possible to combine several vertical stacks, arranged side by side, in a hybrid architecture, in conformity with the description given, for example, in the communication by A. Barnett et al. in the 4th World Photovoltaic Science and Energy Conference, Hawaii, USA, 2006 entitled “50% Efficient Solar Cell Architectures and Designs”. One advantage of solar cells with optical concentrators is that they can have a yield of more than 40%, or even 50%.

In this example, the car windows are also fitted with transparent photovoltaic cells. Photovoltaic cells that can be incorporated in the windshield and in the other car windows are disclosed, in particular, in the article “Titania solar cells: new photovoltaic technology”, which appeared in the review “Renewable Energy”, Volume 22 (2001), pages 303-309. As for the bodywork, the photovoltaic cell array for the windows is preferably subdivided into several areas in which the cells share approximately the same orientation, namely: the windshield 11, the rear window 12, the left side windows 13, and the right side windows 14 (not shown in FIG. 1). In this example, the cells in the same area are interconnected via transparent conductive films.

We know that photovoltaic cells form generators with a strongly nonlinear characteristic. In other words, for the same intensity of illumination, the power delivered will be different depending upon the connected load. Referring to the flow diagram of FIG. 2, it can be seen that the photovoltaic cells are connected area by area to a maximum power point tracker or MPPT 5. MPPT 5 works like a DC-DC converter which automatically optimises the load connected to each area of photovoltaic cells so that the cells permanently supply the maximum available power.

From MPPT 5, the electricity can be directed towards battery 3 so as to charge it, or directly towards electric motors 7, via a converter 9. The controller fitted to MPPT 5 also controls the load connected to battery 3. As soon as the electric power required by motor 7 is more than the power supplied by the photovoltaic cells, the battery starts to contribute. Conversely, as soon as the power supplied by the photovoltaic cells exceeds the requirements of motor 7, the surplus electricity is directed towards the battery to charge it. Moreover, according to an advantageous feature of the present example, electric motor 7 can also operate as a generator. This feature also means that the motor can be used for regenerative braking. During regenerative braking, motor 7 changes into generator mode and uses the electric power produced by the braking of the vehicle to charge battery 3. We should specify that the element referenced 9 in FIG. 2, which, as was already mentioned, normally fulfils the function of converter, operates as a rectifier during braking. Thus, the alternating current produced during regenerative braking is converted into a continuous current suitable for charging battery 3. We should also specify that a conventional braking system is additionally provided to reinforce braking in case of emergency.

Battery 3 is a preferably a battery with high power density storage. It may be, for example, a Lithium ion battery or group of batteries that can store at least 160 Wh (or even 200 Wh) per kg of battery. Because of this feature, it is possible to store 24 kWh (or even 30 kWh) power in a group of batteries whose total weight does not exceed 150 kg. Thus, the extra weight caused by the presence of the batteries in the car is limited and only slightly reduces the autonomy of the vehicle. It should be noted, however, that the weight that has just been indicated does not include the battery cooling system.

According to an advantageous variant, the battery or batteries are batteries that can be charged to up to 80% of their capacity in under 10 minutes. The use of such fast charge batteries makes charging possible during a journey. Indeed, a stop of around 10 minutes in a battery charging station should be considered an acceptable complication by users. The battery or batteries are preferably batteries that can be charged to up to 80% of their capacity within 1 minute maximum. Although not yet available on the market, such batteries should soon be making an appearance. In fact, Toshiba is announcing a Lithium ion battery for 2008 that can be charged to up to 80% within one minute. It is clear that, according to this variant, the possibility of charging the battery or batteries much more slowly also exists, when the available electric power is limited. This possibility is useful for home charging where power is limited, but the available time is relatively long.

It is clear that various alterations and/or improvements evident to those skilled in the art can be made to the embodiment forming the subject of this description without departing from the scope of the present invention defined by the annexed claims. In particular, instead of depositing thin layers of doped silicon directly onto the material forming the bodywork, it is possible to use standard, flexible, photovoltaic cells. These flexible cells can, for example, be bonded to the material forming the core of the various bodywork elements, prior to being coated, if necessary, with a transparent coating.

1-6. (canceled)

7. An electrically powered motor vehicle including at least one electric motor, a rechargeable battery for supplying the motor with electricity and a passenger compartment, the vehicle further including a body made of opaque material and forming a case enclosing the electric motor and the battery as well as the passenger compartment, and further including a windshield made of transparent material and arranged in an aperture in the body, the opaque material in which the body is made including photovoltaic cells arranged on the sides and top of the vehicle so as to generate electricity when the vehicle exterior is exposed to solar radiation, the electricity provided by the photovoltaic cells being supplied to the rechargeable battery and/or the motor, the transparent material in which the windshield is made having transparent photovoltaic cells electrically connected to the rechargeable battery and/or the motor, wherein the rechargeable battery can store at least 160 Wh electric power per kg and be charged to up to 80% of its capacity within 10 minutes, and wherein windows fitted with transparent photovoltaic cells, are arranged in a plurality of apertures in the body, the photovoltaic cells on the sides and top of the body, as well as the photovoltaic cells in the windows, being divided into several areas in which the cells share approximately the same orientation.

8. The electrically powered motor vehicle according to claim 7, wherein the rechargeable battery can store at least 200 Wh of electric power per kg.

9. The electrically powered motor vehicle according to claim 7, wherein the photovoltaic cells carried by the body have a yield of at least 40%.

10. The electrically powered motor vehicle according to claim 9, wherein said photovoltaic cells have a yield of at least 50%.

11. The electrically powered motor vehicle according to claim 7, wherein the rechargeable battery can be charged to up to 80% of its capacity within one minute.

12. The electrically powered motor vehicle according to claim 7, wherein the electric motor can also operate as a generator and in that said motor is for charging the battery when the vehicle is braking.

13. The electrically powered motor vehicle according to claim 8, wherein the photovoltaic cells carried by the body have a yield of at least 40%.
